(19) United States
(12) Patent Application Publication
(10) Pub. No.: US 2023/0242759 A1
(43) Pub. Date: Aug. 3, 2023

(54) POLYMER COMPOSITIONS INCLUDING A POLYAMIDE AND A POLY(ARYLENE SULFIDE) AND CORRESPONDING ARTICLES

(71) Applicant: SOLVAY SPECIALTY POLYMERS USA, LLC, Alpharetta, GA (US)

(72) Inventors: Matthew R. Vincent, Buford, GA (US); Lee Carvell, Cumming, GA (US); Stéphane Jeol, Saint-Genis-Laval (FR); Joel Flores, Alpharetta, GA (US)

(73) Assignee: SOLVAY SPECIALTY POLYMERS USA, LLC, Alpharetta, GA (US)

(21) Appl. No.: 17/998,013

(22) PCT Filed: May 5, 2021
(86) PCT No.: PCT/EP2021/061884

§ 371 Date: Nov. 4, 2022

Related U.S. Application Data
(60) Provisional application No. 63/021,103, filed on May 7, 2020.

(30) Foreign Application Priority Data
Jun. 8, 2020 (EP) 20178774.4

(51) Int. Cl. C08L 77/06; C08G 69/26

(52) U.S. Cl. CPC C08L 77/06; C08G 69/265; C08L 2205/025; C08L 2205/03

(57) ABSTRACT

Described herein are polymer compositions (PC) including a polyamide (PA) and a poly(arylene sulfide) (PASP). The polyamide (PA) is a semi-aromatic polyamide derived from the polycondensation of an aliphatic diamine, a bis(aminoalkyl)cyclohexane, terephthalic acid, and, optionally, a cyclohexanedicarboxylic acid. It was surprisingly discovered that semi-aromatic polyamides derived from the cycloaliphatic diamine bis(aminoalkyl)cyclohexane or the specific combination of the cycloaliphatic diamine bis(aminoalkyl)cyclohexane and the cycloaliphatic dicarboxylic acid cyclohexanedicarboxylic acid provided for polymer compositions (PC) having improved retention of mechanical properties (e.g. tensile modulus and tensile strength) after aging in aqueous polyol solutions. It was also surprisingly discovered that incorporation of a nucleating agent in the polymer composition (PC) provided for significantly improved tensile strength retention after aging. The polymer compositions (PC) can be desirably incorporated into articles that are exposed to elevated temperatures and are designed to convey or store polyol based fluids including, but not limited to, engine coolant.

### CROSS REFERENCE TO RELATED APPLICATIONS

The present application claims priority to U.S. provisional patent application No. 63/021,103, filed on 7 May 2020, and to European patent application no. 63/021,103, filed on 8 Jun. 2020, the whole content of each being incorporated herein by reference for all purposes.

### FIELD OF THE INVENTION

The invention relates to polymer compositions including a polyamide and a poly(arylene sulfide) and having excellent retention of mechanical properties after exposure to aqueous polyol solutions at elevated temperatures. The invention also relates to methods of making the polymer compositions and to articles incorporating the polymer compositions.

### BACKGROUND OF THE INVENTION

Traditionally, semi-aromatic polyamides are used for the manufacture of components exposed to engine coolant. The high chemical resistance and desirable mechanical performance of semi-aromatic polyamides are particularly suited for engine coolant applications. However, because such articles are generally located in engine bays, the articles are exposed to elevated temperatures. Over time, the mechanical performance of such articles degrades to undesirable levels.

In one approach to obtain better mechanical performance retention, blends of semi-aromatic polyamides and poly(arylene sulfides) are used, due to the fact that poly(arylene sulfides) generally have increased hydrolysis resistance at elevated temperatures relative to semi-aromatic polyamides. However, such solutions have yet to provide for desirable increases in mechanical performance retention.

### SUMMARY OF INVENTION

In a first aspect, the invention is directed to a polymer composition (PC) comprising a polyamide (PA) and a poly(arylene sulfide) (PAS); the polyamide (PA) is derived from the polycondensation of monomers in a reaction mixture comprising a diamine component (A) comprising: 20 mol % to 95 mol % of a C₄ to C₁₂ aliphatic diamine and 5 mol % to 80 mol % of bis(aminoalkyl)cyclohexane, wherein mol % is relative to the total moles of each diamine in the diamine component; and a dicarboxylic acid component (B) comprising: 30 mol % to 100 mol % of terephthalic acid and 0 mol % to 70 mol % of a cyclohexanedicarboxylic acid, wherein mol % is relative to the total moles of each dicarboxylic acid in the dicarboxylic acid component. In some embodiments, the bis(aminoalkyl)cyclohexane is 1,3-bis(aminomethyl)cyclohexane or 1,4-bis(aminomethyl)cyclohexane. In some embodiments, the dicarboxylic acid component (B) comprises 1 mol % to 70 mol % of cyclohexanedicarboxylic acid, preferably 1,4-cyclohexanedicarboxylic acid, relative to the total moles of each dicarboxylic acid in the dicarboxylic acid component. In some embodiments, the polymer composition (PC) further comprises, relative to the total weight of the polymer composition (PC), from 0.1 wt. % to 1 wt. % of a nucleating agent. In some embodiments, the polymer composition (PC) comprises, relative to the total weight of the polymer composition, from 5 wt. % to 70 wt. % of a reinforcing agent, preferably the reinforcing agent is a glass fiber or carbon fiber, most preferably a glass fiber.

In some embodiments, the polymer composition (PC) comprises a tensile modulus retention of at least 90% after aging in a 130° C., 50:50 ethylene glycol:water solution for 2000 hours. In some embodiments, the polymer composition (PC) comprises a tensile strength retention of at least 85% after aging in a 130° C., 50:50 ethylene glycol:water solution for 2000 hours.

In another aspect, the invention is directed to an article comprising the polymer composition (PC). In some embodiments, the article is selected from the group consisting of a fluid inlet port, a fluid outlet port, a fluid inlet valve, a fluid outlet valve, a fluid pump housing, a fluid pump impeller, a fluid hose connector, a fluid hose, a fluid reservoir and a fluid valve.

### DETAILED DESCRIPTION OF THE INVENTION

Described herein are polymer compositions (PC) including a polyamide (PA) and a poly(arylene sulfide) (PASP). As explained in detail below, the polyamide (PA) is a semi-aromatic polyamide derived from the polycondensation of an aliphatic diamine, a bis(aminoalkyl)cyclohexane, terephthalic acid, and, optionally, a cyclohexanedicarboxylic acid. It was surprisingly discovered that semi-aromatic polyamides derived from the cycloaliphatic diamine bis(aminoalkyl)cyclohexane or the specific combination of the cycloaliphatic diamine bis(aminoalkyl)cyclohexane and the cycloaliphatic dicarboxylic acid cyclohexanedicarboxylic acid provided for polymer compositions (PC) having improved retention of mechanical properties (e.g. tensile modulus and tensile strength) after aging in aqueous polyol solutions, relative to analogous semi-aromatic polyamides free of the cycloaliphatic diamine bis(aminoalkyl)cyclohexane and the cycloaliphatic dicarboxylic acid cyclohexanedicarboxylic acid. It was also surprisingly discovered that incorporation of a nucleating agent in the polymer composition (PC) provided for significantly improved tensile strength retention after aging. For clarity, as used herein, reference to “aging” implicitly refers to heat aging in an aqueous polyol solution. Due at least in part to the improved retention of mechanical properties after gaining, the polymer compositions (PC) can be desirably incorporated into articles that, during use, are exposed to elevated temperatures and are designed to convey or store polyol based fluids including, but not limited to, engine coolant.

In the present application, any description, even though described in relation to a specific embodiment, is applicable to and interchangeable with other embodiments of the present disclosure. Where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and any recitation herein of numerical ranges by endpoints includes all numbers subsumed within the recited ranges as well as the endpoints of the range and equivalents.

Unless specifically limited otherwise, the term “alkyl”, as well as derivative terms such as “alkoxy”, “acyl” and “alkylthio”, as used herein, include within their scope straight chain, branched chain and cyclic moieties. Examples of alkyl groups are methyl, ethyl, 1-methylethyl, propyl, 1,1-dimethylethyl, and cyclo-propyl. Unless specifically stated otherwise, each alkyl and aryl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied. The term “halogen” or “halo” includes fluorine, chlorine, bromine and iodine, with fluorine being preferred.

The term “aryl” refers to a phenyl, indanyl or naphthyl group. The aryl group may comprise one or more alkyl groups, and are called sometimes in this case “alkylaryl”; for example may be composed of a cycloaromatic group and two C₁-C₆ groups (e.g. methyl or ethyl). The aryl group may also comprise one or more heteroatoms, e.g. N, O or S, and are called sometimes in this case “heteroaryl” group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from but not limited to halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied.

As noted above, it was surprisingly discovered that the polymer compositions (PC) had improved retention of mechanical properties after heat aging in an aqueous polyol solution. A polyol is an organic compound containing at least two hydroxyl groups. Polyols of interest herein include, but are not limited to, ethylene glycol, propylene glycol and diethylene glycol. In general, engine coolant utilizes an aqueous polyol solution that has a weight ratio of water to polyol (e.g. ethylene glycol) of from 99.9/0.1 to 50:50. Retention of mechanical properties can be determined according to following formula: 100*(X₁/X₀), where X₁ is the value of a given mechanical property after aging and X₀ is the value of the mechanical property prior to aging (e.g. as molded). Aging can be performed by submerging the polymer composition (PC) in a 130° C., 50:50 ethylene glycol:water solution for 2000 hours.

In some embodiments, the polymer compositions (PC) has a tensile modulus retention of at least 90%, at least 95%, at least 100% or at least 101%. In some embodiments, the polymer composition (PC) has a tensile modulus retention of no more than 120%, no more than 115% or no more than 110%. In some embodiments, the polymer composition (PC) has a tensile modulus retention of from 90% to 120%, from 95% to 115%, from 100% to 110% or from 101% to 110%. In some embodiments, the polymer composition (PC) has a tensile strength retention of at least 85% or at least 90%. In some embodiments, the polymer composition (PC) has a tensile strength retention of no more than 110%, or no more than 100%. In some embodiments, the polymer composition (PC) has a tensile strength retention of from 85% to 110% or from 90% to 100%. Tensile modulus and tensile strength can be measured as described in the Examples section.

In some embodiments, the polymer composition (PC) has a tensile modulus after aging of at least 7 GPa, at least 10 GPa or at least 13 GPa. In some embodiments, the polymer composition (PC) has a tensile modulus after aging of no more than 25 GPa, no more than 20 GPa or nor more than 17 GPa. In some embodiments, the polymer composition (PC) has a tensile modulus after heat aging of from 7 GPa to 25 GPa, from 10 GPa to 20 GPa or from 13 GPa to 17 GPa. In some embodiments, the polymer composition (PC) has a tensile strength after heat aging of at least 120 MPa, at least 130 MPa or at least 140 MPa. In some embodiments, the polymer composition (PC) has a tensile strength after heat aging of no more than 170 MPa, at least 160 MPa or at least 150 MPa. In some embodiments, the polymer composition (PC) has a tensile strength after heat aging of from 120 MPa to 170 MPa, from 130 MPa to 160 MPa or from 140 MPa to 150 MPa.

In some embodiments, the polymer composition (PC) has a tensile modulus prior to heat aging of at least 7 GPa, at least 10 GPa or at least 12 GPa. In some embodiments, the polymer composition (PC) has a tensile modulus prior to heat aging of no more than 20 GPa, no more than 18 GPa or no more than 16 GPa. In some embodiments, the polymer composition (PC) has a tensile modulus prior to heat aging of from 7 GPa to 20 GPa, from 10 GPa to 18 GPa or from 12 GPa to 16 GPa. In some embodiments, the polymer composition (PC) has a tensile strength prior to heat aging of at least 120 MPa, at least 130 MPa or at least 140 MPa. In some embodiments, the polymer composition (PC) has a tensile strength prior to heat aging of no more than 170 MPa, at least 160 MPa or at least 150 MPa. In some embodiments, the polymer composition (PC) has a tensile strength prior to heat aging of from 120 MPa to 170 MPa, from 130 MPa to 160 MPa or from 140 MPa to 150 MPa.

In some embodiments, the polymer composition (PC) has a flexural modulus prior to heat aging of at least 5 GPa, at least 7 GPa or at least 10 GPa. In some embodiments, the polymer composition (PC) has a flexural modulus prior to heat aging of no more than 20 GPa, no more than 17 GPa or nor more than 15 GPa. In some embodiments, the polymer composition (PC) has a flexural modulus prior to heat aging of from 5 GPa to 20 GPa, from 7 GPa to 17 GPa or from 10 GPa to 15 GPa. In some embodiments, the polymer composition (PC) has a flexural strength prior to heat aging of at least 170 MPa, at least 180 MPa or at least 190 Mpa. In some embodiments, the polymer composition (PC) has a flexural strength prior to heat aging of no more than 215 MPa, no more than 210 MPa or no more than 200 MPa. In some embodiments, the polymer composition (PC) has a flexural strength prior to heat aging of from 170 MPa to 215 MPa, from 180 MPa to 210 MPa or from 190 MPa to 200 MPa. Flexural modulus and flexural strength can be measured as described in the Examples section.

### The Polyamide (PA)

The polymer composition (PC) includes a polyamide (PA). The polyamide (PA) is derived from the polycondensation of monomers in a reaction mixture comprising: (1) a diamine component (A) comprising 20 mol % to 95 mol % of a C₄ to C₁₂ aliphatic diamine and 5 mol % to 80 mol % of a bis(aminoalkyl)cyclohexane, where mol % is relative to the total moles of each diamine monomer in the diamine component; and (2) a dicarboxylic acid component (B) comprising: 30 mol % to 100 mol % of terephthalic acid and 0 mol % to 70 mol %, preferably 1 mol % to 70 mol %, of a cyclohexane dicarboxylic acid, wherein mol % is relative to the total moles of each dicarboxylic acid monomer in the dicarboxylic acid component. It was surprisingly discovered that the incorporation of the bis(aminoalkyl)cyclohexane, or the specific combination of the bis(aminoalkyl)cyclohexane and the cyclohexanedicarboxylic acid, into semi-aromatic polyamides provides for polymer compositions (PC) having improved retention of mechanical properties. The polyamides described herein have a glass transition temperature (“Tg”) of at least 145° C., melting temperature (“Tm”) of at least 295° C., and a heat of fusion (“ΔH_{f}”) of at least 30 J/g.

### The Diamine Component (A)

The diamine component (A) includes all diamines in the reaction mixture, including 20 mol % to 95 mol % C₄ to C₁₂ aliphatic diamine and 5 mol % to 80 mol % of a bis(aminoalkyl)cyclohexane. When referring to the concentration of monomers in the diamine component (A), it will be understood that the concentration is relative to the total number of moles of all diamines in the diamine component (A), unless explicitly noted otherwise.

In some embodiments, the C₄ to C₁₂ aliphatic diamine is represented by the following formula:

H₂N—R₁—NH₂, (1)

where R₁ is a C₄ to C₁₂ alkyl group, preferably a C₆ to C₁₀ alkyl group. In some embodiments, the C₄ to C₁₂ aliphatic diamine is selected from the group consisting of 1,4-diaminobutane (putrescine), 1,5-diaminopentane (cadaverine), 2-methyl-1,5-diaminopentane, hexamethylenediamine (or 1,6-diaminohexane), 3-methylhexamethylenediamine, 2,5-dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, and 1,12-diaminododecane. Preferably, the C₄ to C₁₂ aliphatic diamine is selected from the group consisting of 1,6-diaminohexane, 3-methylhexamethylenediamine, 2,2,4-trimethyl-hexamethylenediamine, 2,4,4-trimethyl-hexamethylenediamine, 1,9-diaminononane, 2-methyl-1,8-diaminooctane, 5-methyl-1,9-diaminononane, and 1,10-diaminodecane. Preferably, the C₄ to C₁₂ aliphatic diamine is a C₅ to C₁₀ aliphatic diamine or a C₅ to C₉ aliphatic diamine. Most preferably, the C₄ to C₁₂ aliphatic diamine is 1,6-diaminohexane.

In some embodiments, concentration of the C₆ to C₁₂ aliphatic diamine is from 25 mol % to 95 mol %, from 30 mol % to 95 mol %, from 35 mol % to 95 mol %, from 40 mol % to 95 mol %, from 45 mol % to 95 mol %, or from 50 mol % to 95 mol %. In some embodiments, concentration of the C₆ to C₁₂ diamine is from 20 mol % to 90 mol %, from 25 mol % to 90 mol %, from 30 mol % to 90 mol %, from 35 mol % to 90 mol %, from 40 mol % to 90 mol %, from 45 mol % to 90 mol %, or from 50 mol % to 90 mol %.

The bis(aminoalkyl)cyclohexane is represented by the following formula:

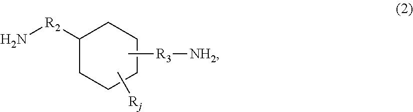

where R₂ and R₃ are independently selected C₁ to C₁₀ alkyls; Rᵢ, at each location, is selected from the group consisting of an alkyl, an aryl, an alkali or alkaline earth metal sulfonate, an alkyl sulfonate, and a quaternary ammonium; and i is an integer from 0 to 10. The —R₃—NH₂ groups are relatively positioned in the meta position (1,3-) or the para position (1,4-). Preferably, i is 0 and R₂ and R₃ are both —CH₂—. Most preferably, the bis(aminoalkyl)cyclohexane is selected from 1,3-bis(aminomethyl)cyclohexane (“1,3-BAC”) and 1,4-bis(aminomethyl)cyclohexane (“1,4-BAC”). Of course, the bis(aminoalkyl)cyclohexane can be in a cis or trans conformation. Accordingly, the diamine component (A) can include only the cis-bis(aminoalkyl)cyclohexane, only trans-bis(aminoalkyl)cyclohexane or a mixture of cis- and trans- bis(aminoalkyl)cyclohexane.

In some embodiments, the concentration of the bis(aminoalkyl)cyclohexane is from 5 mol % to 75 mol %, from 5 mol % to 70 mol %, from 5 mol % to 65 mol %, from 5 mol % to 60 mol %, from 5 mol % to 55 mol %, or from 5 mol % to 50 mol %. In some embodiments, the concentration of the bis(aminoalkyl)cyclohexane is from 10 mol % to 75 mol %, from 10 mol % to 70 mol %, from 10 mol % to 65 mol %, from 10 mol % to 60 mol %, from 10 mol % to 55 mol %, or from 10 mol % to 50 mol %, or from 20 mol % to 40 mol %.

As noted above, in some embodiments, the diamine component (A) includes one or more additional diamines. The additional diamines are distinct from the C₄ to C₁₂ aliphatic diamine and distinct from the bis(aminoalkyl)cyclohexane. In some embodiments, one, some, or all of the additional diamines are represented by Formula (1), each distinct from each other and distinct from the C₄ to C₁₂ aliphatic diamine. In some embodiments, the each additional diamine is selected from the group consisting of 1,2 diaminoethane, 1,2-diaminopropane, propylene-1,3-diamine, 1,3 diaminobutane, 1,4-diaminobutane, 1,5-diaminopentane, 2-methyl-1,5-diaminopentane, 1,6-diaminohexane, 3-methylhexamethylenediamine, 2,5 dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7 tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12-diaminododecane, 1,13-diaminotridecane, 2,5-bis(aminomethyl)tetrahydrofuran and N,N-Bis(3-aminopropyl)methylamine. Included in this category are also cycloaliphatic diamine such as isophorone diamine, 1,3-diaminocyclohexane, 1,4-diaminocyclohexane, bis-p-aminocyclohexylmethane. In some embodiments, the diamine component is free of cycloaliphatic diamines others than the bis(aminoalkyl)cyclohexane. As used herein, free of a monomer (e.g. bis(aminoalkyl)cyclohexane) means that the concentration of the monomer in the corresponding component (e.g. the diamine component (A)) is less than 1 mol %, preferably less than 0.5 mol. %, more preferably less than 0.1 mol %, even more preferably less than 0.05 mol %, most preferably less than 0.01 mol %.

### The Dicarboxylic Acid Component (B)

The dicarboxylic acid component (B) includes all dicarboxylic acids in the reaction mixture, including 30 mol % to 100 mol % of terephthalic acid and 0 mol % to 70 mol %, preferably from 1 mol % to 70 mol %, of a cyclohexanedicarboxylic acid. When referring to the concentration of monomers in the dicarboxylic acid component (B), it will be understood that the concentration is relative to number of moles of all dicarboxylic acids in the dicarboxylic acid component (A), unless explicitly noted otherwise.

In some embodiments, the concentration of the terephthalic acid is from 35 mol % to 100 mol %, from 35 mol % to 100 mol %, from 40 mol % to 100 mol %, from 45 mol % to 100 mol %, or from 50 mol % to 100 mol %. In some embodiments, the concentration of the terephthalic acid is from 30 mol % to 99 mol %, from 35 mol % to 99 mol %, from 40 mol % to 99 mol %, from 45 mol % to 99 mol % or from 50 mol % to 99 mol %. In some embodiments, the concentration of the terephthalic acid is from 30 mol % to 95 mol %, from 35 mol % to 97 mol %, from 40 mol % to 97 mol %, from 45 mol % to 97 mol % or from 50 mol % to 97 mol %.

The cyclohexanedicarboxylic acid is represented by the following formula:

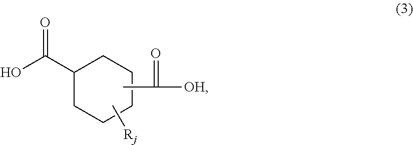

where Rⱼ is selected from the group consisting of an alkyl, an aryl, an alkali or alkaline earth metal sulfonate, an alkyl sulfonate, and a quaternary ammonium; and j is an integer from 0 to 10. The explicit —COOH groups are relatively positioned in the meta position (1,3-) or the para position (1,4-), preferably the para position. Preferably, the cyclohexanedicarboxylic acid is 1,4-cyclohexanedicarboxylic acid (“CHDA”) (j is 0). Of course, the cyclohexanedicarboxylic acid can be in a cis or trans conformation. Accordingly, the dicarboxylic acid component (B) can include only the cis- cyclohexanedicarboxylic acid, only trans-cyclohexanedicarboxylic acid or a mixture of cis- and trans-cyclohexanedicarboxylic acid.

In some embodiments, the concentration of the cyclohexanedicarboxylic acid is from 1 mol % to 70 mol %, from 1 mol % to 65 mol %, from 1 mol %, to 60 mol %, from 1 mol % to 55 mol %, or from 1 mol % to 50 mol. %.

As noted above, in some embodiments, the dicarboxylic acid component (B) includes one or more additional dicarboxylic acids. Each additional dicarboxylic acid is distinct from each other and distinct from the terephthalic acid and the cyclohexanedicarboxylic acid. In some embodiments, one, some, or all of the additional dicarboxylic acids are represented by Formula (3), each distinct from each other and distinct from the cyclohexanedicarboxylic acid.

In some embodiments, the one or more additional dicarboxylic acids are independently selected from the group consisting of C₄ to C₁₂ aliphatic dicarboxylic acids, aromatic dicarboxylic acids, and cycloaliphatic dicarboxylic acids. Examples of desirable C₄ to C₁₀ aliphatic dicarboxylic acids include, but are not limited to, succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], 1,12-dodecanedioic acid [HOOC—(CH₂)₁₀—COOH].

Examples of desirable aromatic dicarboxylic acids include, but are not limited to, phthalic acids, including isophthalic acid (IA), naphthalenedicarboxylic acids (e.g. naphthalene-2,6-dicarboxylic acid), 4,4′ bibenzoic acid, 2,5-pyridinedicarboxylic acid, 2,4-pyridinedicarboxylic acid, 3,5-pyridinedicarboxylic acid, 2,2-bis(4-carboxyphenyl)propane, 2,2 -bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, 2,2-bis(3-carboxyphenyl)hexafluoropropane, 2,2-bis(3-carboxyphenyl)ketone, bis(3-carboxyphenoxy)benzene.

Examples of desirably cycloaliphatic dicarboxylic acids include, but are not limited to, cyclopropane-1,2-dicarboxylic acid, 1-methylcyclopropane-1,2-dicarboxylic acid, cyclobutane-1,2-dicarboxylic acid, tetrahydrofuran-2,5-dicarboxylic acid, 1,3-adamantanedicarboxylic acid.

In some embodiments in which the polyamide (PA) includes one or more additional dicarboxylic acids, the total concentration of the one or more additional dicarboxylic acids is no more than 20 mol. %.

### Recurring Units of the Polyamide (PA)

The polyamide (PA) formed from the polycondensation of the monomers in the diamine component and dicarboxylic acid component, as described above, includes recurring units R_{PA1} and R_{PA2}, represented by the following formulae, respectively:

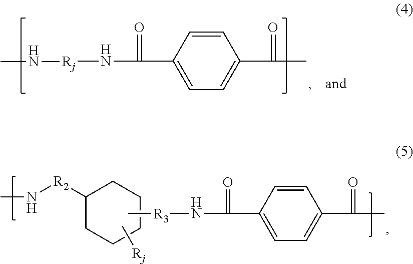

and additionally, when the cyclohexanedicarboxylic acid is present in the dicarboxylic acid component (B), recurring units R_{PA3} and R_{PA4} represented by the following formulae, respectively:

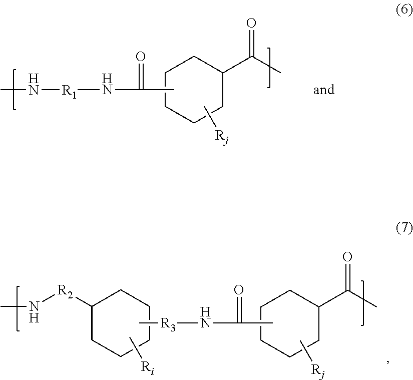

where R₁ to R₃, Rᵢ, Rⱼ, i and j are as defined above. The person of ordinary skill in the art will recognize that recurring unit R_{PA1} is formed from the polycondensation of the C₄ to C₁₂ aliphatic diamine with the terephthalic acid, recurring unit R_{PA3} is formed from the polycondensation of the C₄ to C₁₂ aliphatic diamine with the cyclohexane dicarboxylic acid, recurring unit R_{PA2} is formed from the polycondensation of the bis(aminoalkyl)cyclohexane with the terephthalic acid, and recurring unit R_{PA4} is formed from the polycondensation of the bis(aminoalkyl)cyclohexane with the cyclohexanedicarboxylic acid. In some embodiments, R₁ is —(CH₂)—ₘ, where m is from 5 to 10, preferably from 5 to 9, most preferably 6. Additionally or alternatively, in some embodiments R₂ and R₃ are both —CH₂—, and i and j are both zero. In some embodiments, the bis(aminalkyl)cyclohexane is 1,3-bis(aminomethyl)cyclohexane and the cyclohexanedicarboxylic acid is 1,4-cyclohexane dicarboxylic acid.

In some embodiments, the total concentration of recurring units R_{PA1} and R_{PA2} is at least 50 mol %, at least 60 mol %, at least 70 mol %, at least 80 mol %, at least 90 mol %, at least 95 mol %, at least 97 mol %, at least 98 mol %, at least 99 mol % or at least 99.5 mol %. In some embodiments in which the optional cyclohexanedicarboxylic acid is present in the dicarboxylic acid component (B), the total concentration of recurring units R_{PA1} to R_{PA4} is at least 50 mol %, at least 60 mol %, at least 70 mol %, at least 80 mol %, at least 90 mol %, at least 95 mol %, at least 97 mol %, at least 98 mol %, at least 99 mol % or at least 99.5 mol %. When referring to mol % of a recurring unit, it will be understood that the concentration is relative to the total number of recurring units in the indicated polymer, unless explicitly noted otherwise.

The polyamides (PA) are semi-crystalline polyamides. As used herein, a semi-crystalline polyamide is a polyamide that has a heat of fusion (“ΔH_{f}”) of at least 5 Joules per gram (“J/g”). In some embodiments, the polyamides (PA) described herein have a ΔH_{f} of at least 30 J/g, or at least 35 J/g. Additionally or alternatively, in some embodiments the polyamide (PA) has a ΔH_{f} of no more than 60 J/g or no more than 55 J/g. In some embodiments, the polyamide (PA) has a ΔH_{f} of from 30 J/g to 60 J/g or from 35 J/g to 60 J/g, from 30 J/g to 55 J/g, or from 35 J/g to 55 J/g. ΔH_{f} can be measured according to ASTM D3418 using a heating rate of 20° C./minute.

The polyamide (PA) has a Tg of at least 145° C., preferably at least 150° C. In some embodiments, the polyamide (PA) has a Tg of no more than 190° C., no more than 180° C., or no more than 170° C. In some embodiments, the polyamide (PA) has a Tg of from 145° C. to 190° C., from 145° C. to 180° C., from 145° C. to 170° C., from 150° C. to 190° C., from 150° C. to 180° C., or from 150° C. to 170° C. Tg can be measured according to ASTM D3418.

The polyamide (PA) has a Tm of at least 295° C., preferably at least 300° C. In some embodiments the polyamide (PA) has a Tm of no more than 360° C., no more than 350° C., or no more than 340° C. In some embodiments, the polyamide (PA) has a Tm of from 295° C. to 360° C., from 295° C. to 350° C., from 295° C. to 340° C., 300° C. to 360° C., from 300° C. to 350° C., or from 300° C. to 340° C. Tm can be measured according to ASTM D3418.

In some embodiments, the polyamide (PA) has a number average molecular weight (“Mn”) ranging from 1,000 g/mol to 40,000 g/mol, for example from 2,000 g/mol to 35,000 g/mol, from 4,000 to 30,000 g/mol, or from 5,000 g/mol to 20,000 g/mol. The number average molecular weight Mn can be determined by gel permeation chromatography (GPC) using ASTM D5296 with polystyrene standards.

The polyamide (PA) described herein can be prepared by any conventional method adapted to the synthesis of polyamides and polyphthalamides. Preferentially, the polyamide (PA) is prepared by reacting (by heating) the monomers in presence of less than 60 wt. % of water, preferentially less than 50 wt. %, up to a temperature of at least Tm+10° C., Tm being the melting temperature of the polyamide (PA), where wt. % is relative to the total weight of the reaction mixture.

The polyamide (PA) described herein can for example be prepared by thermal polycondensation (also referred to as polycondensation or condensation) of aqueous solution of monomers and comonomers. In one embodiment, the polyamide (PA) is formed by reacting, in the reaction mixture, at least the C₄ to C₁₂ aliphatic diamine, the bis(aminoalkyl)cyclohexane, the terephthalic acid, and, if present in the dicarboxylic acid component (B), the cyclohexanedicarboxylic acid. In some embodiments, the total number of moles of diamines in the reaction mixture is substantially equimolar to the total number of moles of dicarboxylic acids in the reaction mixture. As used herein, substantial equimolar denotes a value that is ±15% of the indicated number of moles. For example, in the context of the diamine and dicarboxylic acid concentrations in the reaction mixture, total number of moles of diamines in the reaction mixture is ±15% of the total number of moles of dicarboxylic acids in the reaction mixture. The polyamides (PA) may contain a chain limiter, which is a monofunctional molecule capable of reacting with the amine or carboxylic acid moiety, and is used to control the molecular weight of the polyamide (PA). For example, the chain limiter can be acetic acid, propionic acid, benzoic acid and/or benzylamine. A catalyst can also be used. Examples of catalyst are phosphorous acid, ortho-phosphoric acid, meta-phosphoric acid, alkali-metal hypophosphite such as sodium hypophosphite and phenylphosphinic acid. A stabilizer, such as a phosphite, may also be used.

### The Poly(Arylene Sulfide) (PASP)

The polymer composition (PC) includes a poly(arylene sulfide) (PASP). As used herein, a poly(arylene sulfide) refers to any polymer including at least 50 mol % of a recurring unit (R_{PAS}) having the following formula: —[—Ar—S—]—, where Ar is an arylene. In some embodiments, the poly(arylene sulfide) (PASP) has at least 60 mol %, at least 70 mol %, at least 80 mol %, at least 90 mol %, at least 95 mol %, at least 99 mol % or at least 99.9 mol % of recurring unit (R_{PAS}).

In some embodiments, recurring unit (R_{PAS}) is represented by a formula selected from the following group of formulae:

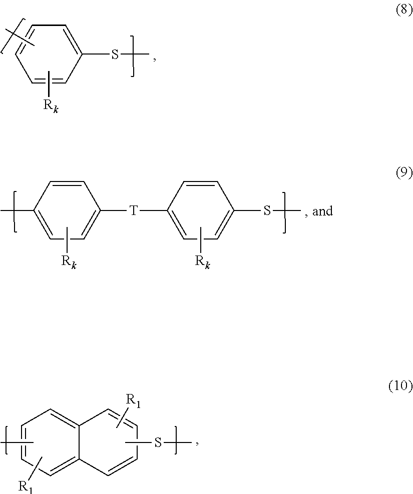

where R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group; T is selected from the group consisting of a bond, —CO—, —SO₂—, —O—, —C(CH₃)₂, phenyl and —CH₂—; k, at each instance, is an independently selected integer from 0 to 4; and 1, at each instance, is an independently selected integer from 0 to 3.

In preferred embodiments, k and 1, at each instance, is zero. Preferably, —Ar— is represented by either Formula (8) or (9), more preferably Formula (8) (recurring unit (R_{PAS}) corresponding to recurring units of polyphenylene sulfide), still more preferably, recurring unit (R_{PAS}) is represented by the following formula:

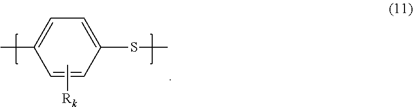

In some embodiments, the concentration of recurring unit (R_{PAS}) in the poly(arylene sulfide) (PASP) is at least 50 mol %, at least 60 mol %, at least 70 mol %, at least 80 mol %, at least 90 mol %, at least 95 mol %, at least 98 mol %, at least 99 mol % or at least 99.9 mol %.

In some embodiments, the poly(arylene sulfide) (PASP) has a weight average molecular weight (“M_{w}”) of at least 10,000 g/mol, at least 20,000 g/mol, at least 25,000 g/mol, at least 30,000 g/mol, or at least 35,000 g/mol. In some embodiments, the poly(arylene sulfide) (PASP) has an M_{w} of no more than 150,000 g/mol, no more than 100,000 g/mol, no more than 90,000 g/mol, no more than 85,000 g/mol, or no more than 80,000 g/mol. In some embodiments, the poly(arylene sulfide) (PASP) has an M_{w} of from 10,000 g/mol to 150,000 g/mol, from 20,000 g/mol to 100,000 g/mol, from 25,000 g/mol to 90,000 g/mol, from 30,000 g/mol to 85,000 g/mol, or from 35,000 g/mol to 80,000 g/mol. M_{w} can be measured with gel permeation chromatography (“GPC”) using a 4-chloronapthalene standard.

The poly(arylene sulfide) (PASP) is semi-crystalline. The person of ordinary skill in the art will recognize that when a polymer is amorphous, it lacks a detectable Tₘ. Accordingly, where a poly(arylene sulfide) (PASP) has a Tm, the person of ordinary skill in the art will recognize that it refers to semi-crystalline polymer. In some embodiments, the poly(arylene sulfide) (PASP) has a ΔH_{f} of at least 10 J/g, at least 20 J/g, at least, or at least 25 J/g. In some embodiments, the poly(arylene sulfide) (PASP) has a ΔH_{f} of no more than 90 J/g, no more than 70 J/g or no more than 60 J/g. In some embodiments, the poly(arylene sulfide) (PASP) has a ΔH_{f} of from 10 J/g to 90 J/g or from 20 J/g to 70 J/g.

In some embodiments, the poly(arylene sulfide) (PASP) has a melting temperature (“Tₘ”) of at least 200° C., at least 220° C., at least 240° C., or at least 250° C. In some embodiments, the poly(arylene sulfide) (PASP) has a Tₘ of no more 350° C., no more than 320° C., no more than 300° C., or no more than 285° C. In some embodiments, the poly(arylene sulfide) (PASP) has a Tₘ of from 200° C. to 350° C., from 220° C. to 320° C., from 240° C. to 300° C., or from 250° C. to 285° C.

### The Polymer Composition (PC)

The polymer composition (C) includes the polyamide (PA) and poly(arylene sulfide) (PASP). In some embodiments, the polymer compositions can include one or more optional components selected from the group consisting of reinforcing agents and additives. Additives include, but are not limited to, tougheners, plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants, nucleating agents, antioxidants, acid scavengers, and other processing aids.

In some embodiments, the polyamide (PA) concentration in the polymer composition (PC) is at least 5 wt. % or at least 10 wt. %. In some embodiments, the polyamide (PA) concentration in the polymer composition (PC) is no more than 80 wt. % or no more than 70 wt. %. In some embodiments, the polyamide (PA) concentration in the polymer composition (PC) is from 5 wt. % to 80 wt. % or from 10 wt. % to 70 wt. %. In some embodiments, the poly(arylene sulfide) (PAS) concentration in the polymer composition (PC) is at least 5 wt. % or at least 10 wt. %. In some embodiments, the poly(arylene sulfide) (PAS) concentration in the polymer composition (PC) is no more than 80 wt. % or no more than 70 wt. %. In some embodiments, the poly(arylene sulfide) (PAS) concentration in the polymer composition (PC) is from 5 wt. % to 80 wt. % or from 10 wt. % to 70 wt. %. As used herein, wt. % is relative to the total weight of the polymer composition, unless explicitly noted otherwise. In some embodiments, the ratio of the weight of the polyamide (PA) to the weight poly(arylene sulfide) (PAS) is from 3:1 to 1:3, from 2.5:1 to 1:2.5, from 2:1 to 1:2, from 1.5:1 to 1:1.5, or 1:1.

In some embodiments, the polymer composition (PC) includes a reinforcing agent. A large selection of reinforcing agents, also called reinforcing fibers or fillers may be added to the polymer composition (PC). In some embodiments, reinforcing agent is selected from mineral fillers (including, but not limited to, talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers and wollastonite.

In general, reinforcing agents are fibrous reinforcing agents or particulate reinforcing agents. A fibrous reinforcing agent refers to a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. In some embodiments, the fibrous reinforcing agent (e.g. glass fibers or carbon fibers) has an average length of from 3 mm to 50 mm. In some such embodiments, the fibrous reinforcing agent has an average length of from 3 mm to 10 mm, from 3 mm to 8 mm, from 3 mm to 6 mm, or from 3 mm to 5 mm. In alternative embodiments, fibrous reinforcing agent has an average length of from 10 mm to 50 mm, from 10 mm to 45 mm, from 10 mm to 35 mm, from 10 mm to 30 mm, from 10 mm to 25 mm or from 15 mm to 25 mm. The average length of the fibrous reinforcing agent can be taken as the average length of the fibrous reinforcing agent prior to incorporation into the polymer composition (PC) or can be taken as the average length of the fibrous reinforcing agent in the polymer composition (PC).

Among fibrous reinforcing agents, glass fibers are preferred. Glass fibers are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. The glass fibers can be added as endless fibers or as chopped glass fibers. The glass fibers have generally an equivalent diameter of 5 to 20 preferably of 5 to 15 μm and more preferably of 5 to 10 μm. All glass fiber types, such as A, C, D, E, M, S, R, T glass fibers (as described in chapter 5.2.3, pages 43-48 of Additives for Plastics Handbook, 2nd ed, John Murphy), or any mixtures thereof or mixtures thereof may be used.

E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminium and magnesium. In particular, those glass fibers comprise typically from 62-75 wt. % of SiO2, from 16-28 wt. % of Al2O3 and from 5-14 wt. % of MgO. On the other hand, R, S and T glass fibers comprise less than 10 wt. % of CaO.

In some embodiments, the glass fiber is a high modulus glass fiber. High modulus glass fibers have an elastic modulus of at least 76, preferably at least 78, more preferably at least 80, and most preferably at least 82 GPa as measured according to ASTM D2343. Examples of high modulus glass fibers include, but are not limited to, S, R, and T glass fibers. A commercially available source of high modulus glass fibers is S-1 and S-2 glass fibers from Taishan and AGY, respectively.

The morphology of the glass fiber is not particularly limited. As noted above, the glass fiber can have a circular cross-section (“round glass fiber”) or a non-circular cross-section (“flat glass fiber”). Examples of suitable flat glass fibers include, but are not limited to, glass fibers having oval, elliptical and rectangular cross sections. In some embodiments in which the polymer composition includes a flat glass fiber, the flat glass fiber has a cross-sectional longest diameter of at least 15 μm, preferably at least 20 μm, more preferably at least 22 μm, still more preferably at least 25 μm. Additionally or alternatively, in some embodiments, the flat glass fiber has a cross-sectional longest diameter of at most 40 μm, preferably at most 35 μm, more preferably at most 32 μm, still more preferably at most 30 μm. In some embodiments, the flat glass fiber has a cross-sectional diameter was in the range of 15 to 35 μm, preferably of 20 to 30 μm and more preferably of 25 to 29 μm. In some embodiments, the flat glass fiber has a cross-sectional shortest diameter of at least 4 μm, preferably at least 5 μm, more preferably at least 6 μm, still more preferably at least 7 μm. Additionally or alternatively, in some embodiments, the flat glass fiber has a cross-sectional shortest diameter of at most 25 μm, preferably at most 20 μm, more preferably at most 17 μm, still more preferably at most 15 μm. In some embodiments, the flat glass fiber has a cross-sectional shortest diameter was in the range of 5 to 20 preferably of 5 to 15 μm and more preferably of 7 to 11 μm.

In some embodiments, the flat glass fiber has an aspect ratio of at least 2, preferably at least 2.2, more preferably at least 2.4, still more preferably at least 3. The aspect ratio is defined as a ratio of the longest diameter in the cross-section of the glass fiber to the shortest diameter in the same cross-section. Additionally or alternatively, in some embodiments, the flat glass fiber has an aspect ratio of at most 8, preferably at most 6, more preferably of at most 4. In some embodiments, the flat glass fiber has an aspect ratio of from 2 to 6, and preferably, from 2.2 to 4. In some embodiments, in which the glass fiber is a round glass fiber, the glass fiber has an aspect ratio of less than 2, preferably less than 1.5, more preferably less than 1.2, even more preferably less than 1.1, most preferably, less than 1.05. Of course, the person of ordinary skill in the art will understand that regardless of the morphology of the glass fiber (e.g. round or flat), the aspect ratio cannot, by definition, be less than 1.

In some embodiments, the reinforcing agent (e.g. glass or carbon fibers) concentration in the polymer composition (PC) is at least 5 wt. %, at least 10 wt. %, at least 15 wt. % or at least 20 wt. %. In some embodiments, the reinforcing agent concentration in the polymer composition (PC) is no more 70 wt. %, no more than 65 wt. % or no more than 60 wt. %. In some embodiments, the reinforcing agent concentration in the polymer composition (PC) is from 5 wt. % to 70 wt. %, from 10 wt. % to 70 wt. %, from 10 wt. % to 65 wt. %, from 10 wt. % to 60 wt. %, from 15 wt. % to 60 wt. %, or from 20 wt. % to 60 wt. %.

With respect to additives, at noted above, it was surprisingly discovered that polymer compositions (PC) including a nucleating agent had significantly improved tensile strength retention after heat aging, relative to polymer compositions (PC) free of a nucleating agent. In some embodiments, the nucleating agent is selected from the group consisting of talc, metal carbonates (e.g. calcium carbonate and magnesium carbonate), boron nitride, titanium oxide, titanium dioxide, cellulose particles, a poly(ether ether ketone) and nanocrystalline cellulose. In some embodiments, the nucleating agent concentration in the polymer composition (PC) is at least 0.1 wt. %, at least 0.2 wt. % or at least 0.3 wt. %. In some embodiments, the nucleating agent concentration in the polymer composition (PC) is no more than 1 wt. %, no more than 0.8 wt. % or no more than 0.7 wt. %. In some embodiments, the nucleating agent concentration is from 0.1 wt. % to 1 wt. %, from 0.2 wt. % to 0.8 wt. % or from 0.3 wt. % to 0.7 wt. %.

In some embodiments, the polymer composition (PC) includes a toughener. A toughener is generally a low Tg, with a Tg for example below room temperature, below 0° C. or even below −25° C. As a result of its low Tg, the tougheners are typically elastomeric at room temperature. Tougheners can be functionalized polymer backbones.

The polymer backbone of the toughener can be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

In some embodiments, the toughener concentration in the polymer composition (PC) is at least 1 wt. %, at least 2 wt. % or at least 3 wt. %. In some embodiments, the toughener concentration in the polymer composition (PC) is no more than 20 wt. %, no more than 15 wt. % or no more than 10 wt. %. In some embodiments, the toughener concentration is the polymer composition (PC) is from 1 wt. % to 20 wt. %, from 2 wt. % to 15 wt. % or from 3 wt. to 10 wt. %.

In some embodiments, the halogen-free flame retardant is an organophosphorous compound selected from the group consisting of phosphinic salts (phosphinates), diphosphinic salts (diphosphinates) and condensation products thereof. Preferably, the organophosphorous compound is selected from the group consisting of phosphinic salt (phosphinate) of the formula (I), a diphosphinic salt (diphosphinate) of the formula (II) and condensation products thereof:

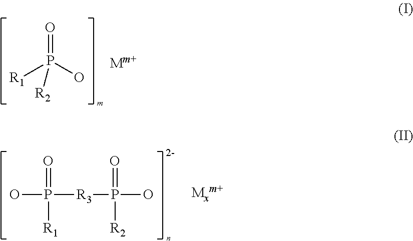

wherein, R₁, R₂ are identical or different and each of R₁ and R₂ is a hydrogen or a linear or branched C₁-C₆ alkyl group or an aryl group; R₃ is a linear or branched C₁-C₁₀ alkylene group, a C₆-C₁₀ arylene group, an alkyl-arylene group, or an aryl-alkylene group; M is selected from calcium ions, magnesium ions, aluminum ions, zinc ions, titanium ions, and combinations thereof; m is an integer of 2 or 3; n is an integer of 1 or 3; and xis an integer of 1 or 2.

Preferably, R₁ and R₂ are independently selected from methyl, ethyl, n-propyl, isopropyl, n-butyl, tert-butyl, n-pentyl, and phenyl; R3 is selected from methylene, ethylene, n-propylene, isopropylene, n-butylene, tert-butylene, n pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene, and phenylbutylene; and M is selected from aluminum and zinc ions.

Phosphinates are preferred as organophosphorous compound. Suitable phosphinates have been described in U.S. Pat. No. 6,365,071, incorporated herein by reference. Particularly preferred phosphinates are aluminum phosphinates, calcium phosphinates, and zinc phosphinates. Excellent results were obtained with aluminum phosphinates. Among aluminum phosphinates, aluminium ethylmethylphosphinate and aluminium diethylphosphinate and combinations thereof are preferred.

In some embodiments, the polymer composition (PC) further includes an acid scavenger, most desirably in embodiments incorporating a halogen free flame retardant. Acid scavengers include, but are not limited to, silicone; silica; boehmite; metal oxides such as aluminum oxide, calcium oxide iron oxide, titanium oxide, manganese oxide, magnesium oxide, zirconium oxide, zinc oxide, molybdenum oxide, cobalt oxide, bismuth oxide, chromium oxide, tin oxide, antimony oxide, nickel oxide, copper oxide and tungsten oxide; metal powder such as aluminum, iron, titanium, manganese, zinc, molybdenum, cobalt, bismuth, chromium, tin, antimony, nickel, copper and tungsten; and metal salts such as barium metaborate, zinc carbonate, magnesium carbonate, calcium carbonate, and barium carbonate. In some embodiments, in which the polymer composition (PC) includes an acid scavenger, the acid scavenger concentration is from 0.01 wt. % to 5 wt. %, from 0.05 wt. % to 4 wt. %, from 0.08 wt. % to 3 wt. %, from 0.1 wt. % to 2 wt. %, from 0.1 wt. % to 1 wt. %, from 0.1 wt. % to 0.5 wt. % or from 0.1 wt. % to 0.3 wt. %.

In some embodiments, the total additive concentration in the polymer composition (PC) is at least 0.1 wt. %, at least 0.2 wt. % or at least 0.3 wt. %. In some embodiments, the total additive concentration in the polymer composition (PC) is no more than 20 wt. %, no more than 15 wt. %., no more than 10 wt. %, no more than 7 wt. % or no more than 5 wt. %. In some embodiments, the total additive concentration in the polymer composition (PC) is from 0.1 wt. % to 20 wt. %, from 0.1 wt. % to 15 wt. %, from 0.1 wt. % to 10 wt. %, from 0.2 wt. % to 7 wt. % or from 0.3 wt. to 5 wt. %.

In some embodiments, the polymer composition (PC) further includes one or more additional polymers. In some such embodiments, at least one of the additional polymers is a semi-crystalline or amorphous polyamides, such as aliphatic polyamides, semi-aromatic polyamides, and more generally a polyamide obtained by polycondensation between an aromatic or aliphatic saturated diacid and an aliphatic saturated or aromatic primary diamine, a lactam, an amino-acid or a mixture of these different monomers.

### Preparation of the Polymer Composition (PC)

The invention further pertains to a method of making the polymer composition (PC). The method involves melt-blending the polyamide (PA), the poly(arylene sulfide) (PASP) and any optional components (e.g. reinforcing agent and nucleating agent).

Any melt-blending method may be used for mixing polymeric ingredients and non-polymeric ingredients in the context of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, long fibers as well as continuous fibers), drawing extrusion or pultrusion may be used to prepare a reinforced composition.

### Articles and Applications

The present invention also relates to articles comprising the polymer composition (PC). At least in part due to the improved mechanical retention after heat aging, the polymer compositions (PC) are desirably incorporated into any article that is exposed elevated temperatures and aqueous polyol solutions during their intended use.

In some embodiments, the article is selected from the group consisting of automotive components, marine components, and aerospace components. In some embodiments, the article is selected from the group consisting of fluid inlet/outlet ports, fluid inlet/outlet valves, fluid pump housings, fluid pump impellers, fluid hose connectors, fluid hoses, fluid reservoirs and fluid valves, where the fluid is an aqueous polyol solution, preferably an aqueous solution of ethylene glycol, propylene glycol or diethylene glycol. The polymer compositions (PC) are even further advantageously incorporated into such aritcles when such articles are used within engine bays (e.g. exposed to elevated temperatures).

In some embodiments, the article is molded from the polymer composition (PC) by any process adapted to thermoplastics, e.g. extrusion, injection molding, blow molding, rotomolding or compression molding. The polymer composition (C) may also be used in overmolding pre-formed shapes to build hybrid structures.

In some embodiments, the article is printed from the polymer composition (PC) by a process including a step of extruding the polymer composition (PC), which is for example in the form of a filament, or including a step of laser sintering the polymer composition (PC), which is in this case in the form of a powder.

The present invention also relates to a method for manufacturing a three-dimensional (3D) object with an additive manufacturing system, including: providing a part material including the polymer composition (PC), and printing layers of the three-dimensional object from the part material.

The polymer composition (PC) can therefore be in the form of a thread or a filament to be used in a process of 3D printing, e.g. Fused Filament Fabrication, also known as Fused Deposition Modelling (“FDM”).

The polymer composition (PC) can also be in the form of a powder, for example a substantially spherical powder, to be used in a process of 3D printing, e.g. Selective Laser Sintering (“SLS”).

Use of the Polymer Compositions (PC) and Articles

The present invention relates to the use of the polymer composition (PC) or articles for manufacturing an automotive component, marine component or an aerospace component, as described above. The present invention also relates to the use of the polymer composition (PC) for 3D printing an object.

### EXAMPLES

The present examples demonstrate the synthesis, thermal performance, and mechanical performance of the polyamides.

The raw materials used to form the samples as provided below:
Poly(arylene sulfide): PPS (from Solvay Specialty Polymers USA, L.L.C.)
Polyamide 1 (“PA1”): PA 6T/6I/66 (from Solvay Specialty Polymers USA, L.L.C.; Tg =125° C. and Tm=310° C.), respectively.
Polyamide 2 (“PA2”): PA 6,T/1,3-BAC,T/6,CHDA/1,3-BAC,CHDA (Tg=165° C. and Tm=330° C.)), synthesized from
   Hexamethylenediamine (70 wt %, from Ascend Performance Materials)
   1,3-bis(aminomethyl)cyclohexane (from Mitsubishi Gas Chemical Company)
   Terephthalic Acid (from Flint Hills Resources)
   1,4-Cyclohexanedicarboxylic Acid (from Eastman Chemical Company)
Nucleating Agent: Talc (Mistron Vapor, from Imerys)
Reinforcing Filler: Glass Fiber. Chopped E-glass fiber (NEG 779H, from Nippon Electric Glass)
Pigment: Black Pigment. PLASBLACK® un2014 Black Pigment (from Cabot).

### Example 1—Synthesis of PA1

This example demonstrates the synthesis of Polyamide 1.

PA 1 was prepared in an autoclave reactor equipped with a distillate line fitted with a pressure control valve. The reactor was charged with 498 g of 70% hexamethylenediamine, 165 g of 1,3-bis(aminomethyl)cyclohexane, 635 g of terephthalic acid, 20 g of 1,4-cyclohexanedicarboxylic acid, 355 g of deionized water, 7.2 g of glacial acetic acid and 0.32 g of phosphorus acid. The reactor was sealed, purged with nitrogen and heated to 260° C. The steam generated was slowly released to keep the internal pressure at 120 psig. The temperature was increased to 335° C. The reaction mixture was kept at 335° C. for 60 minutes while the reactor pressure was reduced to atmospheric. The polymer was discharged from the reactor and used in the preparation of the compound formulations.

### Example 2—Mechanical Performance

This example demonstrates the mechanical performance of the polymer compositions.

To demonstrate mechanical performance, polymer compositions were formed by melt blending the polymer resins (PPS, PA1 or PA2) with various additives in an extruder. The polymer compositions were then molded into test samples and mechanical properties (tensile and flexural properties) were tested prior to (“as molded”) and subsequent to (“after aging”) test sample aging. Aging involved submerging the test samples, in a 50:50 ethylene glycol:water solution at 130° C. for 2000 hours. Tensile modulus, tensile strength and tensile elongation were measured according to ISO 527-2 on dumbbell-shaped, ISO type 1A tensile specimens with the following nominal dimensions: full length of 170 mm, gauge length of 75 mm, parallel section length of 80 mm, parallel section width of 10 mm, grip section width of 20 mm, and thickness of 4 mm. Flexural modulus, flexural strength and flexural elongation were measured according to ISO 178 on standard, ISO flexural specimens with the following nominal dimensions: length of 80 mm, width of 10 mm, and thickness of 4 mm. Tables 1 and 2 display sample parameters and tensile properties, respectively. In the Tables, “E” refers to an example and “CE” refers to a counter example. All values in Table 1 are reported in wt. %.

TABLE 1

| Component | E1 | E2 | CE1 | CE2 |
|---|---|---|---|---|
| PPS | 29 | 29 | 29 | 29 |
| PA1 | | | 29 | 29 |
| PA2 | 29 | 29 | | |
| Talc | | 0.5 | | 0.5 |
| Black Pigment | 1.5 | 1.5 | 1.5 | 1.5 |
| Glass Fiber | 40 | 40 | 40 | 40 |

TABLE 2

| Component | | E1 | E2 | CE1 | CE2 |
|---|---|---|---|---|---|
| Tensile | As Molded | 14.7 | 15.0 | 15.6 | 15.8 |
| Modulus | After Aging | 15.1 | 15.4 | 13.7 | 13.8 |
| (GPa) | % Retention | 102.5 | 102.4 | 88.0 | 87.3 |
| Tensile | As Molded | 147 | 149 | 166 | 166 |
| Strength | After Aging | 132.9 | 143.1 | 133.9 | 135.1 |
| (MPa) | % Retention | 90.6 | 95.7 | 80.9 | 81.5 |
| Flexural | As Molded | 13.0 | 13.4 | 13.8 | 14.3 |
| Modulus | After Aging | | | | |
| (GPa) | % Retention | | | | |
| Flexural | As Molded | 196 | 198 | 232 | 235 |
| Strength | After Aging | | | | |
| (MPa) | % Retention | | | | |

Referring to Table 2, the samples including PA2 surprisingly had increased retention of tensile properties, as well as increased values of tensile properties, after aging, relative to the samples including PA1. For example, E1 and E2 had significantly increased % retention of tensile modulus and strength, relative to CE1 and CE2, respectively. Furthermore, after aging, E1 and E2 also had increased tensile modulus and strength, relative to CE1 and CE2.

Furthermore, it was surprisingly found that the samples including a nucleating agent in addition to PA2 had increased tensile strength retention, relative to samples including PA2 that were free of a nucleating agent. For example, while E1 had about a 12% increase in tensile strength retention relative to CE1, E2 had about a 17% increase in tensile strength retention relative to CE2.

The embodiments above are intended to be illustrative and not limiting. Additional embodiments are within the inventive concepts. In addition, although the present invention is described with reference to particular embodiments, those skilled in the art will recognized that changes can be made in form and detail without departing from the spirit and scope of the invention. Any incorporation by reference of documents above is limited such that no subject matter is incorporated that is contrary to the explicit disclosure herein.

1. A polymer composition (PC) comprising:
a polyamide (PA);
a poly(arylene sulfide) (PAS);
wherein
the polyamide (PA) is derived from the polycondensation of monomers in a reaction mixture comprising:
a diamine component (A) comprising:
20 mol % to 95 mol % of a C₄ to C₁₂ aliphatic diamine and
5 mol % to 80 mol % of bis(aminoalkyl)cyclohexane, wherein mol % is relative to the total moles of each diamine in the diamine component;
a dicarboxylic acid component (B) comprising:
30 mol % to 100 mol % of terephthalic acid and
0 mol % to 70 mol % of a cyclohexanedicarboxylic acid, wherein mol % is relative to the total moles of each dicarboxylic acid in the dicarboxylic acid component.

2. The polymer composition (PC) of claim 1, wherein the C₄ to C₁₂ aliphatic diamine is selected from the group consisting of 1,4-diaminobutane, 1,5-diaminopentane, 2-methyl-1,5-diaminopentane, 1,6-diaminohexane, 3 -methylhexamethylenediamine, 2,5-dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12-diaminododecane, and combinations thereof.

3. The polymer composition (PC) of claim 1, wherein the bis(aminoalkyl)cyclohexane is 1,3-bis(aminomethyl)cyclohexane or 1,4-bis(aminomethyl)cyclohexane.

4. The polymer composition (PC) of claim 1, wherein the dicarboxylic acid component (B) comprises 1 mol % to 70 mol % of cyclohexanedicarboxylic acid relative to the total moles of each dicarboxylic acid in the dicarboxylic acid component.

5. The polymer composition (PC) of claim 1, wherein the polyamide (PA) concentration is from 5 wt. % to 80 wt. %, based on the total weight of the polymer composition (PC).

6. The polymer composition (PC) of claim 1, wherein the poly(arylene sulfide) is polyphenylene sulfide.

7. The polymer composition (PC) of claim 1, wherein the poly(arylene sulfide) concentration is from 5 wt. % to 80 wt. %, based upon the total weight of the polymer composition (PC).

8. The polymer composition (PC) of claim 1, further comprising, relative to the total weight of the polymer composition (PC), from 0.1 wt. % to 1 wt. % of a nucleating agent.

9. The polymer composition (PC) of claim 1, further comprising, relative to the total weight of the polymer composition, from 5 wt. % to 70 wt. % of a reinforcing agent.

10. The polymer composition (PC) of claim 9, wherein the reinforcing agent is glass fiber or carbon fiber.

11. The polymer composition (PC) of claim 1, wherein the polymer composition (PC) comprises a tensile modulus retention of at least 90% after aging in a 130° C., 50:50 ethylene glycol:water solution for 2000 hours.

12. The polymer composition (PC) of claim 1, wherein the polymer composition (PC) comprises a tensile strength retention of at least 85% after aging in a 130° C., 50:50 ethylene glycol:water solution for 2000 hours.

13. An article comprising the polymer composition of claim 1, wherein the article is selected from the group consisting of a fluid inlet port, a fluid outlet port, a fluid inlet valve, a fluid outlet valve, a fluid pump housing, a fluid pump impeller, a fluid hose connector, a fluid hose, a fluid reservoir a fluid valve, and combinations thereof.

14. The article of claim 13, wherein the article is in contact with an aqueous polyol solution.

15. The article of claim 13, wherein the article is exposed to a temperature of at least 130° C.
